(19) United States
(12) Patent Application Publication
(10) Pub. No.: US 2008/0066633 A1
(43) Pub. Date: Mar. 20, 2008

(54) Freight Loading System of Trailer

(76) Inventor: Sang Ho Han, Seoul (KR)

Correspondence Address: RABIN & Berdo, PC, 1101 14TH STREET, NW, SUITE 500, WASHINGTON, DC, 20005, US

(21) Appl. No.: 11/631,605

(22) PCT Filed: Jan. 13, 2005
(86) PCT No.: PCT/KR05/00105

§ 371 Date: Jan. 5, 2007

(30) Foreign Application Priority Data
Jul. 9, 2004 (KR) 10-2004-0053311

(51) Int. Cl. B41F 17/34; B41F 17/30

(52) U.S. Cl. 101/35

(57) ABSTRACT

Disclosed herein is a printer for golf balls which can print various images on the surfaces of golf balls. The printer of the present invention includes a main body (10), a print head (20) which discharges ink and moves in a transverse direction, a head cleaner (30) which cleans a nozzle of the print head, and a support plate (40) which moves in a direction perpendicular to a moving direction of the print head. The printer further includes a golf ball receiving plate (50), which is mounted on the support plate, a guide unit (45), which guides the support plate, and a control unit (60) which controls operation of the print head, the head cleaner and the support plate. The printer further includes a head detecting sensor (73), which detects the position of the print head, a rear sensor (72) which detects whether the support plate is at a rear position, and a front sensor (71) which detects whether the support plate is at a front position.

### TECHNICAL FIELD

The present invention relates, in general, to printers for golf balls and, more particularly, to a printer for golf balls which can print various images on the surfaces of golf balls according to the individual preferences of users in a manner of producing many different kinds of products in small quantities, thus meeting the demands of various users.

### BACKGROUND ART

Generally, golf is a kind of outdoor sport which has recently gained popularity. To play the golf game, each golfer strikes a golf ball with golf clubs towards a hole which is relatively far from the tee shot position. The winner is the player who accumulates the lowest number of strokes until the golf ball is put into the hole.

Recently, golf balls on which company logos, trademarks or particular patterns are printed have been marketed in order to enhance the appearance of the golf balls and distinguish them.

A conventional method of printing a special image on the surface of a golf ball will be explained herein below.

First, a desired output image is made using a computer or by a manual method. This image is printed on film or photographic paper through a typical printing method. This is processed through a copperplate printing process and, thereafter, is put into a rotary press for golf balls (the rotary press has therein a hole having a golf ball shape), so that the desired image is printed on the golf ball.

However, in the conventional golf ball printing method, the number of colors to be expressed is limited according to the kind of rotary press. Furthermore, because the copperplate must be manufactured, a lot of time is required and printing costs increase.

To express various colors, a method using a sticker, which is stuck on a golf ball, was proposed. However, because additional time and equipment are required to manufacture the sticker, costs increase, so that this method cannot be popularized.

Furthermore, the conventional golf ball printing method produces a small variety of products in large quantities. Consequently, it is difficult to meet various demands of users having various individual preferences.

### DISCLOSURE OF INVENTION

### Technical Problem

Accordingly, the present invention has been made keeping in mind the above problems occurring in the prior art, and an object of the present invention is to provide a printer for golf balls which can rapidly and easily print various images (including a photographic image as well as a logo) on the surfaces of golf balls according to the individual preferences of users at a low cost, thus meeting the demands of the users.

### Technical Solution

In order to accomplish the above objects, the present invention provides a printer for golf balls, including: a main body; a print head provided on a surface of the main body and discharging an oil-based ink supplied from an ink tank while being moved by both a drive motor and a power transmission unit in a transverse direction; a head cleaner cleaning a nozzle of the print head; a support plate provided on a bottom of the main body and moved by both a drive motor and a power transmission unit in a direction perpendicular to a moving direction of the print head; a golf ball receiving plate removably mounted on the support plate and having a plurality of seat holes therein, so that a plurality of golf balls is placed in the seat holes; a guide unit guiding movement of the support plate; a control unit controlling operation of the print head, the head cleaner and the support plate; a head detecting sensor detecting a position of the print head; a rear sensor provided at a lower rear position in the main body and detecting whether the support plate is at a rear position; and a front sensor provided at a lower front position in the main body and detecting whether the support plate is at a front position.

Preferably, the power transmission unit of the support plate may include a plurality of pulleys and a plurality of wrapping connectors to transmit a driving force from the drive motor to the support plate, and a portion of a final-stage wrapping connector of the wrapping connectors may be fastened at a predetermined position to a lower surface of the support plate.

Furthermore, a coupling structure between the golf ball receiving plate and the support plate may include a plurality of locking protrusions and locking holes selectively provided in adjacent edges of the golf ball receiving plate and the support plate.

Preferably, the guide unit may include a first outer guide member mounted to the lower surface of the support plate by a locking unit; a second outer guide member mounted on a support block provided on the bottom of the main body; a first inner guide member guided alongside an inner surface of the first outer guide member; a second inner guide member guided alongside an inner surface of the second outer guide member; and a plurality of sliding balls interposed both between the first inner and outer guide members and between the second inner and outer guide members, the sliding balls being in rolling contact with the first and second inner and outer guide members.

Preferably, the control unit may include a first controller connected to the drive motor of the print head and controlling operation of the print head; and a second controller connected to the first controller and being selectively connected to one of the drive motor of the head cleaner and the drive motor of the support plate through a relay. The first and second controllers may be connected to an outside power supply in parallel, and the front and rear sensors and the head detecting sensor may be connected to the second controller.

The printer may further include an inside power supply connected to the control unit.

### ADVANTAGEOUS EFFECTS

In the present invention, a printer for golf balls can rapidly and easily print various images on the surfaces of golf balls according to the individual preferences of users at a low cost, thus meeting the demands of the users.

### BRIEF DESCRIPTION OF THE DRAWINGS

FIG. 1 is a perspective view of a printer for golf balls, according to an embodiment of the present invention;

FIG. 2 is a front view of the printer for golf balls according to the embodiment of the present invention;

FIG. 3 is a plan sectional view showing a support plate and related components of the printer for golf balls according to the present invention;

FIG. 4 is a side sectional view showing the support plate and related components of the printer for golf balls according to the present invention; and

FIG. 5 is a block diagram schematically showing a control circuit of the printer for golf balls according to the embodiment of the present invention.

### BEST MODE FOR CARRYING OUT THE INVENTION

Hereinafter, a preferred embodiment of the present invention will be described in detail with reference to the attached drawings.

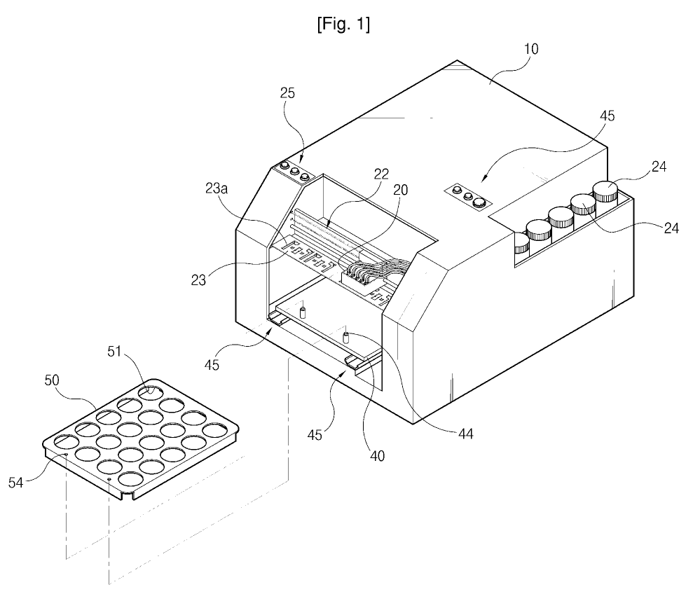

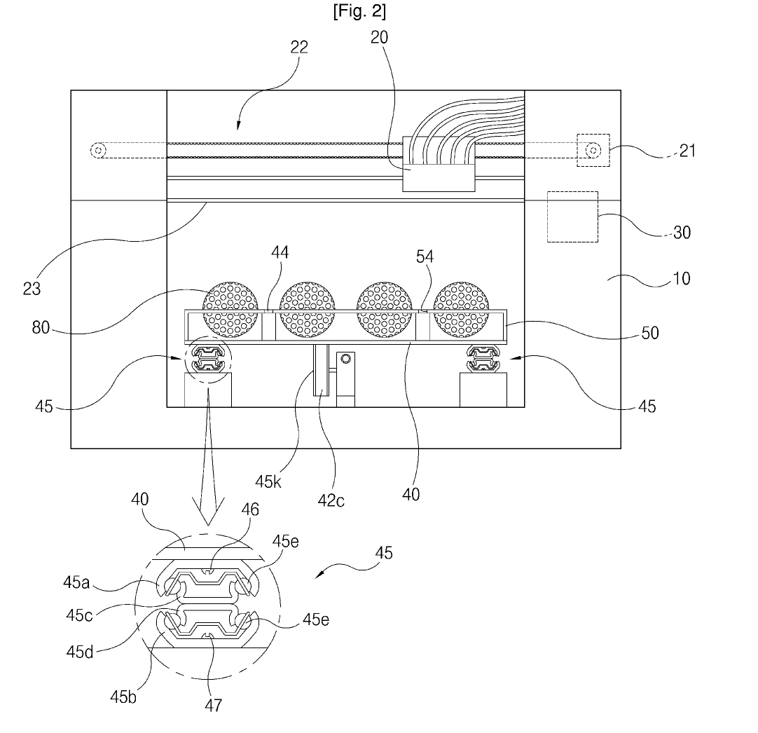

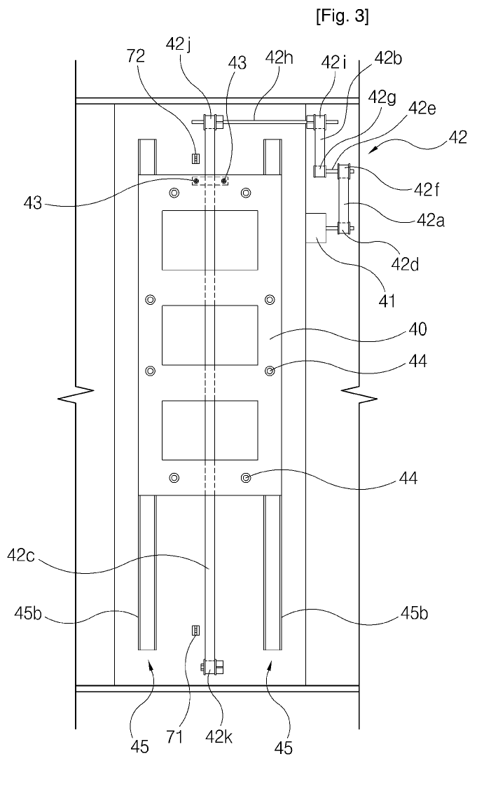

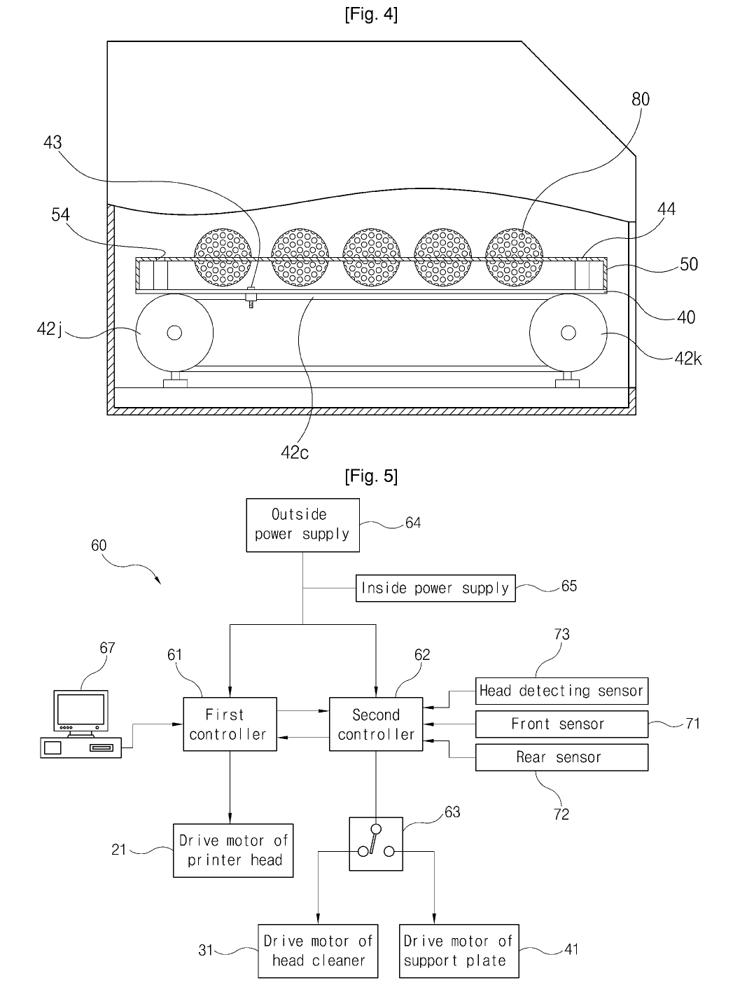

FIGS. 1 through 5 show a printer for golf balls according to the preferred embodiment of the present invention.

As shown in the drawings, the printer of the present invention includes a main body 10 which defines the external shape, a print head 20 which is provided on a surface of the main body and is movable in a transverse direction, and a head cleaner 30 which cleans a nozzle of the print head 20. The printer further includes a support plate 40 which is provided on the bottom of the main body and is movable forwards and rearwards, a golf ball receiving plate 50 which is removably mounted on the support plate 40, and a pair of guide units 45 which are provided on both sides of the support plate 40 and guide the support plate 40, thus securing stable horizontal movement of the support plate 40. The printer further includes a control unit 60 which controls the operation of the print head 20, the head cleaner 30 and the support plate 40, a front sensor 71 which is disposed at a lower front position in the main body 10 and detects whether the support plate 40 is at a front position, a rear sensor 72 which is disposed at a lower rear position in the main body 10 and detects whether the support plate 40 is at a rear position, and a head detecting sensor 73 which detects the position of the print head 20.

Furthermore, a plurality of ink tanks 24 having variously colored ink therein is separately mounted to a surface of the main body 10 so that the ink tanks 24 are easily removable. The main body 10 is open at a front end thereof. A print head control button unit 25 and a support plate control button unit 45 which will be described later herein are provided on a surface of the main body 10 in a state of being exposed outside.

The print head 20 has the same structure as that of a typical print head and is movable in a transverse direction by a drive motor 21 and a power transmission unit 22. The print head 20 is provided in the open front end of the main body in a state of being exposed outside. The nozzle (not shown) is provided under the print head 20. Oil-based ink, which has a variety of colors and is supplied from the plurality of ink tanks 21 is directly discharged onto the surfaces of golf balls 80 through the nozzle of the print head 20. A guide plate 23 is provided below the nozzle of the print head 20 and guides the discharged oil-based ink to the surfaces of the golf balls 80. A plurality of guide holes 23a having predetermined shapes is formed through the guide plate 23.

The head cleaner 30 is provided at a predetermined position on a path along which the print head 20 moves, and the head cleaner 30 serves to periodically clean the nozzle of the print head 20.

The support plate 40 is disposed on the bottom of the main body 10 and is moved on the bottom of the main body 10 by a drive motor 41 and a power transmission unit 42 in a direction perpendicular to the direction in which the print head 20 moves.

The power transmission unit 42, which transmits driving force from the drive motor 41 to the support plate 40 to move the support plate 40 forwards or backwards, comprises a plurality of pulleys 42d, 42f, 42g, 42i, 42j and 42k and a plurality of wrapping connectors 42a, 42b and 42c.

The first wrapping connector 42a is coupled between the drive pulley 42d, which is provided on the output shaft of the drive motor 41, and the first driven pulley 42f, which is provided on a first end of a first rotating shaft 42e that is rotatably disposed behind the drive motor 41. The second wrapping connector 42b is coupled between the second driven pulley 42g, which is provided on a second end of the first rotating shaft 42e, and the third driving pulley 42i, which is provided on a first end of a second rotating shaft 42h that is disposed in back of the first rotating shaft 42e. The third wrapping connector 42c is coupled between the fourth driven pulley 42j, which is provided on a second end of the second rotating shaft 42h, and the fifth driven pulley 42k, which is disposed at lower and front position in the main body 10. Furthermore, a portion of the third wrapping connector 42c is fastened at a predetermined position in a lower surface of the support plate 40 by a locking unit 43.

Here, various kinds of wrapping connectors, such as belts, chains, ropes, etc. may be used as the first through third wrapping connectors 42a, 42b and 42c.

According to the above-mentioned construction, when the drive motor 41 is operated, the third wrapping connector 42c conducts a desired orbital motion. Then, the support plate 40, which is fastened to the third wrapping connector 42c, moves forwards and backwards.

A plurality of seat holes 51, in each of which a golf ball 80 is seated, is formed in the upper surface of the golf ball receiving plate 50 in a matrix arrangement. The golf ball receiving plate 50 is removably mounted to the upper surface of the support plate 40.

Preferably, as shown in FIG. 1, the coupling structure between the golf ball receiving plate 50 and the support plate 40 comprises a plurality of locking holes 54, which are formed in an edge of the golf ball receiving plate 50, and a plurality of locking protrusions 44 which are provided on an edge of the support plate 40, thus making it possible for the golf ball receiving plate 50 to be easily removably coupled to the support plate 40.

The guide units 45 are provided on both sides of the support plate 40 so as to ensure stable horizontal movement of the support plate 40.

Each guide unit 45 includes a first outer guide member 45a which is mounted to the lower surface of the support plate 40 by a locking unit 46, and a second outer guide member 45b which is mounted on a support block 13 provided on the bottom of the main body 10 by a locking unit 47. The guide unit 45 further includes a first inner guide member 45c which is guided alongside the inner surface of the first outer guide member 45a, and a second inner guide member 45d which is guided alongside the inner surface of the second outer guide member 45b. The guide unit 45 further includes a plurality of sliding balls 45e which are interposed both between the first inner and outer guide members 45a and 45c and between the second inner and outer guide members 45b and 45d. The sliding balls 45e are in rolling contact with the first and second inner and outer guide members.

As such, the double guide structure of the guide unit 45 ensures the stability of the horizontal movement of the support plate 40.

The control unit 60 controls the operation of the print head 20, the head cleaner 30 and the support plate 40.

Preferably, the control unit 60 includes a first controller 61 which is connected to the drive motor 21 of the print head 20 and controls the operation of the print head 20, and a second controller 62 which is selectively connected to one of the drive motor 31 of the head cleaner 30 and the drive motor 41 of the support plate 40 through a relay 63. An outside power supply 64 is connected to the first and second controllers 61 and 62 in parallel.

The first controller 61 is connected to a computer 67 and controls the print head 20 such that the print head 20 selectively prints various images on each golf ball 80 or golf balls 80 in rows according to a program which was previously set in the computer 67. The print head control button unit 25 is connected to the first controller 61 having the above-mentioned structure.

The second controller 62 is selectively connected to the drive motor 31 of the head cleaner 30 and the drive motor 41 of the support plate 40 through the relay 63 and thus selectively controls the operation of one of the head cleaner 30 and the support plate 40. The support plate control button unit 45 is connected to the second controller 62 having the above-mentioned structure.

Furthermore, the first and second controller 61 and 62 are connected to each other to send and receive signals.

The front sensor 71 is provided at a lower front position in the main body 10 so as to detect whether the support plate 40 is at a front position. The front sensor 71 is connected to the second controller 62.

The rear sensor 72 is provided at a lower rear position in the main body 10 so as to detect whether the support plate 40 is at a rear position. The rear sensor 71 is also connected to the second controller 62.

The head detecting sensor 73 is provided on a path along which the print head 20 moves in a transverse direction so as to detect the position of the print head 20. The head detecting sensor 73 is also connected to the second controller 62.

As an alternative, an inside power supply 65 may be connected to the control unit 60. This is to stably supply power even when the outside power supply 64 is interrupted due to an incident such as the interruption of electric power.

The operation of the present invention having the above-mentioned construction will be described herein below in detail.

First, golf balls 80 are seated into the seat holes 51 of the golf ball receiving plate 50, which is in the state of being separated from the support plate 40. Thereafter, the golf ball receiving plate 50 is securely mounted to the support plate 40.

Subsequently, when the outside power supply 64 is turned on, power is applied to the first controller 61 and the second controller 62. Then, the first controller 61 controls the drive motor 21 of the print head 20, so that the print head 20 moves in a transverse direction and directly discharges a predetermined amount of oil-based ink onto the plurality of golf balls 80, which are seated in the golf ball receiving plate 50.

At this time, the print head 20 is operated such that images are printed according to the program, which was previously set in the computer 67 connected to the first controller 61.

Simultaneously, the second controller 62 controls the drive motor 41 of the support plate 40, such that the support plate 40 moves in a direction perpendicular to the moving direction of the print head 20.

As such, the print head 20 moves in a transverse direction and discharges a pre-determined amount of oil-based ink while the golf ball receiving plate 50 moves forwards and backwards along with the support plate 40. After the desired printing operation is finished, a process of cleaning the nozzle of the print head 20 may be conducted.

To conduct the process of cleaning the nozzle of the print head 20, as shown in FIG. 5, a contact point of the relay 63 is brought into contact with a contact point of the drive motor 31 of the head cleaner 30 by the second controller 62. Then, power from the outside power supply 64 is applied to the drive motor 31 of the head cleaner 30, so that the head cleaner 30 is operated, thus cleaning the nozzle of the print head 20.

To resume the printing process, the contact point of the relay 63 is brought into contact with a contact point of the drive motor 41 of the support plate 40 by the second controller 62. As a result, the support plate 40 moves forwards and backwards and conducts the printing process.

Although the preferred embodiment of the invention has been disclosed for illustrative purposes, the present invention is not limited to the above-mentioned embodiment. Those skilled in the art will appreciate that various modifications, additions and substitutions are possible, without departing from the scope and spirit of the invention as disclosed in the accompanying claims.

1: A printer for golf balls, comprising:
a main body;
a print head provided on a surface of the main body and discharging an oil-based ink supplied from an ink tank while being moved by both a drive motor and a power transmission unit in a transverse direction;
a head cleaner cleaning a nozzle of the print head;
a support plate provided on a bottom of the main body and moved by both a drive motor and a power transmission unit in a direction perpendicular to a moving direction of the print head;
a golf ball receiving plate removably mounted on the support plate and having a plurality of seat holes therein, so that a plurality of golf balls is placed in the seat holes;
a guide unit guiding movement of the support plate;
a control unit controlling operation of the print head, the head cleaner and the support plate;
a head detecting sensor detecting a position of the print head;
a rear sensor provided at a lower rear position in the main body and detecting whether the support plate is at a rear position; and
a front sensor provided at a lower front position in the main body and detecting whether the support plate is at a front position.

2: The printer for golf balls according to claim 1, wherein the power transmission unit of the support plate comprises a plurality of pulleys and a plurality of wrapping connectors to transmit a driving force from the drive motor to the support plate, and a portion of a final-stage wrapping connector of the wrapping connectors is fastened at a predetermined position to a lower surface of the support plate.

3: The printer for golf balls according to claim 1 or 2, wherein a coupling structure between the golf ball receiving plate and the support plate comprises a plurality of locking protrusions and locking holes selectively provided in adjacent edges of the golf ball receiving plate and the support plate.

4: The printer for golf balls according to claim 3, wherein the guide unit comprises:
a first outer guide member mounted to the lower surface of the support plate by a locking unit; a second outer guide member mounted on a support block provided on the bottom of the main body; a first inner guide member guided alongside an inner surface of the first outer guide member; a second inner guide member guided alongside an inner surface of the second outer guide member; and a plurality of sliding balls interposed both between the first inner and outer guide members and between the second inner and outer guide members, the sliding balls being in rolling contact with the first and second inner and outer guide members.

5: The printer for golf balls according to claim 1, wherein the control unit comprises:
a first controller connected to the drive motor of the print head and controlling operation of the print head; and
a second controller connected to the first controller and being selectively connected to one of the drive motor of the head cleaner and the drive motor of the support plate through a relay, wherein
the first and second controllers are connected to an outside power supply in parallel, and the front and rear sensors and the head detecting sensor are connected to the second controller.

6: The printer for golf balls according to claim 5, further comprising:
an inside power supply connected to the control unit.

7: The printer for golf balls according to claim 2, wherein a coupling structure between the golf ball receiving plate and the support plate comprises a plurality of locking protrusions and locking holes selectively provided in adjacent edges of the golf ball receiving plate and the support plate.
